(19) United States
(12) Patent Application Publication
(10) Pub. No.: US 2018/0122153 A1
(43) Pub. Date: May 3, 2018

(54) PARKING LOT MANAGEMENT METHOD, PORTABLE TERMINAL, AND PARKING LOT MANAGEMENT SYSTEM

(71) Applicant: PARKINGCLOUD CO., LTD., Seoul (KR)

(72) Inventor: Sang Yong SHIN, Seoul (KR)

(21) Appl. No.: 15/560,872

(22) PCT Filed: Dec. 16, 2015
(86) PCT No.: PCT/KR2015/013787

§ 371 Date: Sep. 22, 2017

(30) Foreign Application Priority Data
Mar. 31, 2015 (KR) 10-2015-0044944

(51) Int. Cl. G07B 15/04; G07F 17/24; G06Q 20/32; G06Q 20/38; G08G 1/14

(52) U.S. Cl. CPC G07B 15/04; G07F 17/24; G08G 1/14; G06Q 20/325; G06Q 20/387; G06Q 20/3223

(57) ABSTRACT

A parking lot management method, a portable terminal, and a parking lot management system where the method includes the steps of: receiving a remote call request; identifying a manager's portable terminal used by a manager of a parking lot that has sent the remote call request; transmitting to the identified manager's portable terminal a connection request for connection with a device that has sent the remote call request; and upon receipt of a response to the connection request for connection with the device, establishing a video channel between the manager's portable terminal and the device that has sent the remote call request, wherein the manager's portable terminal receives a video signal of a camera provided at the device through the video channel.

### BACKGROUND

The present invention relates to a parking lot management method, a portable terminal, and a parking lot management system. More particularly, the present invention relates to a parking lot management method, a portable terminal, and a parking lot management system, wherein various management functions of a parking lot are achieved by a mobile phone, and control of vehicle entry and exit into and from the parking lot and parking fee settlement are remotely achieved.

As well known in the art, there are a number of parking lots in and around a city centre. Such parking lots have entrance and exit gates and provide a parking space for a vehicle entering via the entrance gate. There are parking attendants at the entrance and exit gates of the parking lot, and the parking attendants calculate the parking fee based on the confirmation of the entry time and the exit time and collect the parking fee. As such, a parking lot generally has parking attendants who processes and receives parking fees.

In order to provide smooth entry and exit of vehicles, there is a parking lot that adopts a License Plate Recognition (LPR) system. The LPR system automatically recognizes the vehicle license plate number through the camera at the entrance gate and also recognizes the vehicle license plate number through the camera at the exit gate.

The LPR system is configured such that the parking fee of a corresponding vehicle can be determined using the automatically recognized vehicle license plate number at the entrance and exit gates, and the parking fee can be paid to the parking attendant at the exit gate.

As described above, in the case of the LPR parking system that has been applied in recent years, it is possible only to automatically recognize the vehicle license plate number of the vehicle entering or exiting the parking lot. However, the parking settlement is performed manually.

The conventional parking fee settlement systems have various inconveniences. For example, the conventional parking fee settlement system requires the presence of a parking attendant, which leads to unnecessary costs.

Further, automation of the parking fee settlement system can be considered. For example, the exit gate device may recognize the parking ticket that has been automated and settled through an automated payment machine, and open the exit gate according to the recognition. The collection of parking fee through the automated payment machine provides convenience. However, it is difficult to cope with various special situations, so a parking attendant is still required to be present. For example, there may be difficulties in cash payment and in discount processing.

Accordingly, there is a demand for a parking lot management method, a portable terminal, and a parking lot management system, in which the payment of parking fee can be remotely controlled and automated without requiring a parking attendant.

Further, if a mobile phone can be used to manage the parking lot remotely, it may provide various conveniences.

### SUMMARY OF THE INVENTION

Accordingly, the present invention has been made keeping in mind the above problems occurring in the prior art, and an object of the present invention is to provide a parking lot management method, a portable terminal, and a parking lot management system, in which control of vehicle entry and exit and parking fee settlement of the parking lot are achieved by using and controlling the mobile phone.

Another object of the present invention is to provide a parking lot management method, a portable terminal, and a parking lot management system, in which management of the parking lot is achieved by the mobile phone.

A further object of the present invention is to provide a parking lot management method, a portable terminal, and a parking lot management system, in which remote conversation with a parking lot user is achieved and the gate for the parking lot is allowed to be opened and closed remotely for the user.

However, the technical problem which is intended to be solved by the present invention is not limited to the above aspects, and other technical problems will be able to be apparently understood by those skilled in the art from the following description.

In order to accomplish the above object, the present invention provides a parking lot management method including the steps of: receiving a remote call request; identifying a manager's portable terminal used by a manager of a parking lot that has sent the remote call request; transmitting to the identified manager's portable terminal a connection request for connection with a device that has sent the remote call request; and upon receipt of a response to the connection request for connection with the device, establishing a video channel between the manager's portable terminal and the device that has sent the remote call request, wherein the manager's portable terminal receives a video signal of a camera provided at the device through the video channel.

In order to accomplish the above object, the present invention provides a parking lot management method including the steps of: receiving a connection request; executing an application program in response to the connection request and transmitting a response to the connection request; and receiving a video signal through a video channel established with a device of the parking lot that has induced the connection request and displaying the video signal.

In order to accomplish the above object, the present invention provides a portable terminal that remotely manages the parking lot, and includes: a communication unit receiving a connection request and transmitting a response to the connection request; a control unit executing an application program in response to the connection request through the communication unit, generating the response to the connection request, and forwarding the response to the communication unit, the control unit establishing the video channel with the device of the parking lot that has induced the connection request, and decoding the video signal from the established video channel; and a display unit outputting the decoded video signal.

In order to accomplish the above object, the present invention provides a parking lot management system including the portable terminal that remotely manages the parking lot, wherein the portable terminal includes: a communication unit receiving a connection request and transmitting a response to the connection request; a control unit executing an application program in response to the connection request through the communication unit, generating the response to the connection request, and forwarding the response to the communication unit, the control unit establishing the video channel with the device of the parking lot that has induced the connection request, and decoding the video signal from the established video channel; and a display unit outputting the decoded video signal.

As described above, in the parking lot management method, the portable terminal, and the parking lot management system according to the present invention, it is possible to achieve control of vehicle entry and exit into and from the parking lot and parking fee settlement by using and controlling the mobile phone.

In addition, in the parking lot management method, the portable terminal, and the parking lot management system according to the present invention, it is possible to achieve various management functions of the parking lot by the mobile phone.

Further, in the parking lot management method, the portable terminal, and the parking lot management system according to the present invention, it is possible to achieve remote conversation with the parking lot user and to allow the gate for the parking lot to be opened and closed remotely for the user.

It will be appreciated by those skilled in the art that that the effects that can be achieved through the present invention are not limited to what has been particularly described hereinabove and other advantages of the present invention will be more clearly understood from the following detailed description.

### BRIEF DESCRIPTION OF THE INVENTION

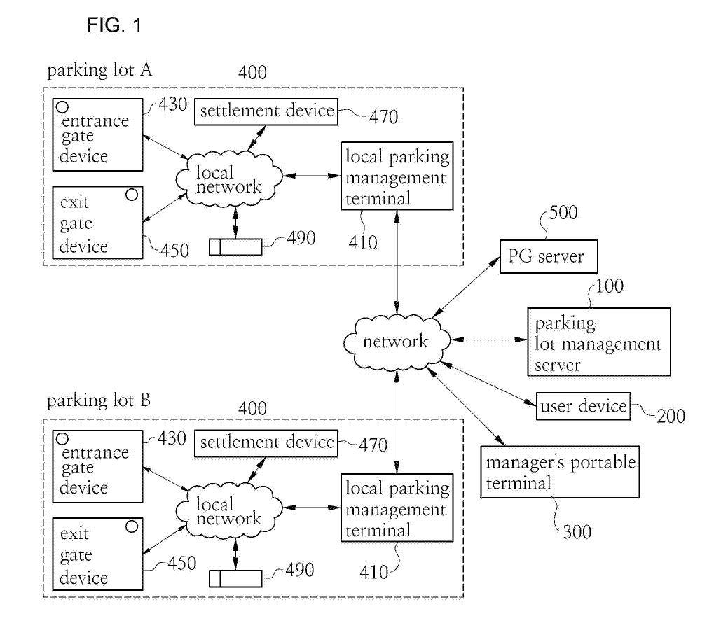

FIG. 1 is an exemplary system block diagram showing a parking lot management system.

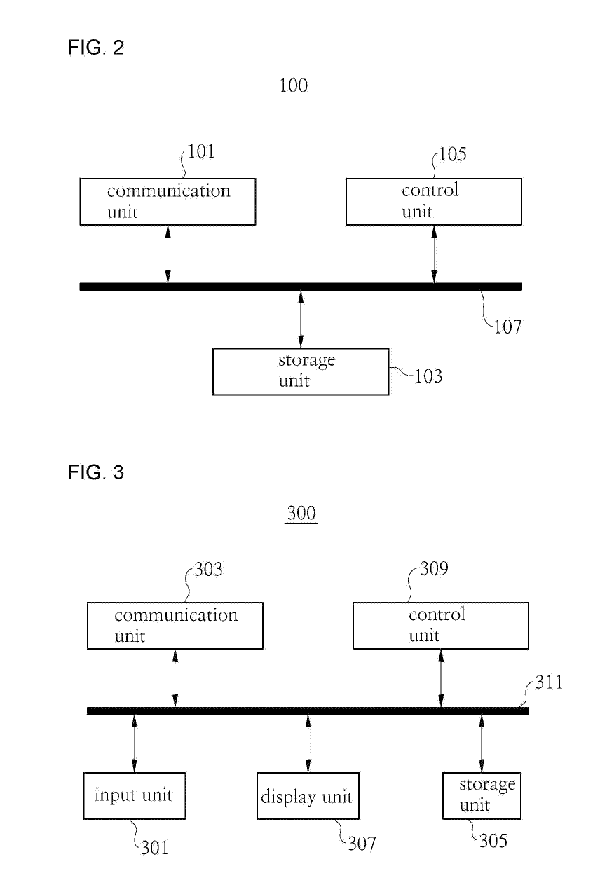

FIG. 2 is an exemplary system block diagram showing a parking lot management server.

FIG. 3 is an exemplary system block diagram showing a manager's portable terminal.

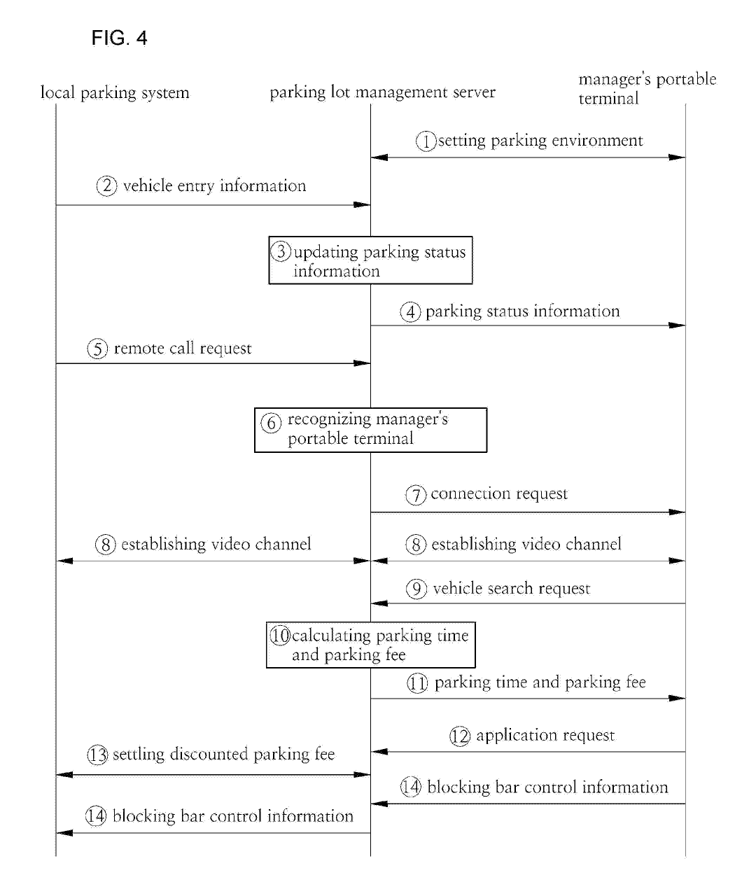

FIG. 4 is a view showing an exemplary control flow in which remote control of a parking lot is achieved utilizing the manager's portable terminal.

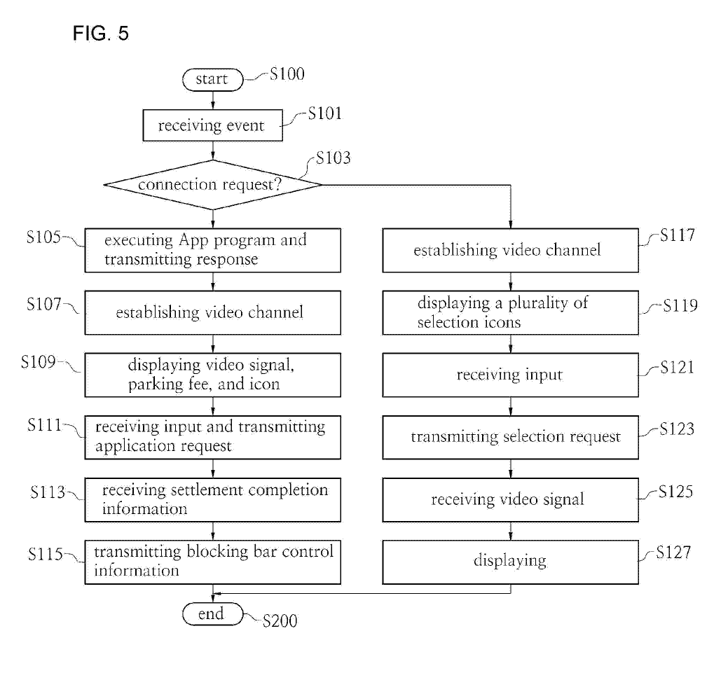

FIG. 5 is a view showing an exemplary parking management control flow in the manager's portable terminal by interworking with the parking lot management server.

### DETAILED DESCRIPTION OF THE INVENTION

The above and other objects, features and advantages of the present invention will be more clearly understood from the following detailed description taken in conjunction with the accompanying drawings. Accordingly, the present invention can be easily embodied by those skilled in the art to which this invention belongs. In the following description of the present invention, detailed descriptions of known functions and components incorporated herein will be omitted when it may make the subject matter of the present invention unclear. Hereinbelow, exemplary embodiments of the present invention will be described in detail with reference to the accompanying drawings.

FIG. 1 is an exemplary system block diagram showing a parking lot management system.

Referring to FIG. 1, the parking lot management system includes a parking lot management server 100, at least one user device 200, at least one manager's portable terminal 300, at least one local parking system 400, and a PG server 500. The parking lot management system may further include other devices.

Each block of the parking lot management system will be described with reference to FIG. 1. The parking lot management server 100 is a server for managing parking lots registered in the present system. The parking lot management server 100 may be connected to a plurality of local parking systems 400 or a plurality of user devices 200, and is configured to process requests from the local parking system 400 (local parking management terminal 410) or the user device 200 and forward the processing result. The parking lot management server 100 functions as, for example, a HyperText Transfer Protocol (HTTP) server to provide various web pages to the local parking system 400 or the user device 200 and to receive data through the web pages.

The parking lot management server 100 enables automatic parking fee payment and automatic parking fee settlement through data communication with the user device 200. In addition, the parking lot management server 100 is configured such that when the automatic parking fee settlement is impossible, the parking lot management server allows the parking fee to be settled by interworking the manager's portable terminal 300 and the local parking system 400 with each other.

The parking lot management server 100 is at least configured to identify the manager's portable terminal 300 managing the parking system 400 according to information received from the local parking management terminal 410 and to transmit a message based on the received information to the identified manager's portable terminal 300.

The parking lot management server 100 will be described in detail with reference to FIG. 2 and below.

The user device 200 is a device that can be used by a user. The user device 200 may be a portable or stationary device. The user device 200 may be, for example, a mobile phone or a personal PC. The mobile phone may be a smartphone or a tablet PC or the like. The user device 200 can access the parking lot management server 100 through the Internet and can receive and transmit various messages related to vehicle entry and exit into and from the parking lot, and payment from/to the parking lot management server 100 through a network.

The user device 200 is generally a device possessed by a vehicle user, and is preferably a mobile phone. The mobile phone can be accessed using a mobile phone number assigned by a mobile carrier through a mobile communication network or an internet network. The mobile phone possessed by the vehicle user receives a message indicating a vehicle entry guide or a vehicle exit guide from the parking lot management server 100 that manages a parking lot where the vehicle enters, and displays the received message on a display module (e.g., LCD, LED module) of the mobile phone.

The local parking system 400 installed at one parking lot is configured with a plurality of devices. The local parking system 400 may include an entrance gate device 430, an exit gate device 450, and a local parking management terminal 410 and may further include a settlement device 470 and at least one camera 490. The devices are connected to each other through a local network and can transmit and receive data and signals.

The entrance gate device 430 is a device that is installed at the entrance gate of the parking lot. The entrance gate device 430 includes a camera module, a control module, a communication module, and an input/output module. The camera module captures an image of an entering vehicle and the control module extracts a vehicle license plate number from the captured vehicle image. The vehicle license plate number can be extracted using an optical character reader (OCR) program. The entrance gate device 430 transmits the extracted vehicle license plate number, the entry time, and the vehicle image to the local parking management terminal 410 through the local network.

The entrance gate device 430 includes the input/output module, and the input/output module includes an input button or a touch button for calling a manager for call and conversation with the manager, a speaker, a microphone, etc. The input/output module enables a remote call, a remote conversation with the manager, and control from the manager. The manager can open the gate of the corresponding entrance gate device 430 through the manager's portable terminal 300.

The exit gate device 450 is a device that is installed at the exit gate of the parking lot. The exit gate device 450 includes a camera module, a control module, a communication module, an input/output module, and a blocking bar. The control module of the exit gate device 450 extracts the vehicle license plate number through the camera module and transmits the vehicle license plate number to the local parking management terminal 410 together with the vehicle image and an exit time, and then receives a control signal from the local parking management terminal to open the blocking bar according to the control signal, or to output the corresponding signal or data designated to the signal to the input/output module.

For example, the exit gate device 450 can receive a control signal according to completion of automatic parking fee settlement from the local parking management terminal 410 and open the blocking bar. Alternatively, the exit gate device 450 can receive from the local parking management terminal 410 a control signal indicating that the parking fee settlement is not made and can inform it through the input/output module.

The exit gate device 450 includes the input/output module, and the input/output module includes an input button or a touch button for calling the manager for call and conversation with the manager, a speaker, a microphone, etc. The input/output module enables a remote call, a remote conversation with the manager, and control from the manager. The manager can open the gate (blocking bar) of the corresponding exit gate device 450 through the manager's portable terminal 300.

The local parking management terminal 410 stores various data related to vehicle entry and exit into and from the parking lot, and calculates a parking fee according to the vehicle exit. The local parking management terminal 410 can identify a member who pre-purchased a parking ticket (parking product) by interworking with the parking lot management server 100. For example, the local parking management terminal 410 can provide the parking lot management server 100 with the parking product (e.g., a daily ticket, a weekly ticket, a monthly ticket, etc.) provided by the corresponding parking lot, and receive an identifier of a user (member) using the corresponding parking product together with an identifier of the parking product and store them in advance.

In order for the local parking management terminal 410 to perform various functions, the local parking management terminal 410 includes at least a processor, a storage medium, and a communication module. The processor can load a program stored in the storage medium (e.g., a hard disk) to manage the corresponding parking lot. The communication module includes a chipset for connection to the Internet or the local network, and transmits and receives various data to/from the entry and exit gate devices 430 and 450 through the local network, and transmits and receives various data to/from the parking lot management server 100 through the Internet or the like.

The local parking management terminal 410 receives signals indicating call requests from various devices and generates a remote call request to transmit the remote call request to the parking lot management server 100 or the manager's portable terminal 300. The local parking management terminal 410 generates the remote call request upon receipt of an input from the input/output module of each device, etc., and then the local parking management terminal 410 transmits the remote call request to the manager's portable terminal 300 through the network. The remote call request is forwarded directly to the manager's portable terminal 300 or is forwarded thereto via the parking lot management server 100.

Further, the local parking management terminal 410 can generate a video channel by interworking with the manager's portable terminal 300. The generated video channel is generated under arbitration of the parking lot management server 100. A video signal selected from a plurality of camera images is transmitted to the manager's portable terminal 300 through the corresponding video channel. To this end, the local parking management terminal 410 is configured to receive a video channel selection signal from the manager's portable terminal 300 and to transmit a video signal selected from video signals of a plurality of cameras 490 or camera modules to the video channel. The video channel may further include an audio channel. Accordingly, an audio signal connected to a specific camera (module) can be transmitted together with the video signal.

The settlement device 470 is a device that settles the parking fee. The settlement device 470 includes a control module, a payment means recognition module, a communication module, a camera module, and an input/output module. The settlement device 470 receives an input of the user using the parking lot through the input/output module. For example, the settlement device 470 can receive the vehicle license plate number of a vehicle of the user and receive a discount coupon or the like. The settlement device 470 can call the manager through the input/output module when the automatic settlement is impossible (e.g., a paper discount coupon, a non-member, etc.).

The settlement device 470 includes the input/output module, and the input/output module includes an input button or a touch button for calling the manager for call and conversation with the manager, a speaker, a microphone, etc. The input/output module enables a remote call, a remote conversation with the manager, control from the manager, discount of the parking fee, and the like. The settlement device 470 can transmit and receive data to/from the local parking management terminal 410 through the local network or transmit and receive data through a dedicated network.

The parking lot may be provided with a plurality of cameras 490. The camera 490 captures an image of a certain area within the parking lot. The captured image can be transmitted to the local parking management terminal 410 through the local network or a dedicated network (line). In the following, the terms camera and camera module are used in combination. The camera module is preferably used to clarify that it is provided in a specific device.

The specific processing performed in the local parking system 400 will be described with reference to FIG. 4 and the like.

The manager's portable terminal 300 is a terminal that is possessed by the manager of the parking lot. The manager's portable terminal 300 is a terminal capable of managing the parking lot remotely without being connected to the local network of the parking lot. The manager's portable terminal 300 may be, for example, a mobile phone. The mobile phone may be, for example, a smartphone.

The manager's portable terminal 300 is provided with an application program for managing the parking lot remotely and can manage the corresponding parking lot by executing the application program. In addition, the manager's portable terminal 300 is configured to receive a connection request according to the remote call request input from various devices of the parking lot, and to receive and display a video signal of the corresponding device.

Further, the manager's portable terminal 300 is configured to be connected to the parking lot management server 100 to confirm various information. For example, the manager's portable terminal 300 can receive vehicle entry and exit details of the parking lot, parking product purchase details, current parking status information, and the like, and display the corresponding information. In addition, the manager's portable terminal 300 can search for the vehicle license plate number, calculate the parking fee of the searched vehicle license plate number, and request settlement of the parking fee. Thus, the manager's portable terminal 300 is connected to the parking lot management server 100 or the local parking system 400 to perform various controls.

The PG server 500 is a server that is operated by a payment gateway. The PG server 500 provides various functions related to authentication, approval, and payment of a credit card. Through the PG server 500, it is possible to pre-purchase the parking product, process the parking fee in real time, and process a deferred payment of the parking fee.

The network transmits and receives data. The network is connected to various devices to transmit and receive data packets between the devices. The network may include a local area network and a broadband network. The network includes a mobile communication network and further includes an Internet network. The mobile communication network may be recognized as a part of the Internet network.

FIG. 2 is an exemplary system block diagram showing a parking lot management server.

Referring to FIG. 2, the parking lot management server 100 includes a communication unit 101, a storage unit 103, a connection unit 107, and a control unit 105. The block diagram of FIG. 2 preferably represents a functional block diagram, and the parking lot management server 100 is provided with hardware for implementing the functional block diagram.

For example, the parking lot management server 100 includes a LAN card for connection with a wired or wireless LAN, a LAN chipset, at least one hard disk for storing programs and various data, at least one processor for executing the programs, and parallel/serial buses for transmitting and receiving various digital data between the processor, the hard disk, and the LAN card.

Alternatively, the parking lot management server 100 is configured as a combination of at least one computer, a workstation, a data storage server, and the like such that a specific one or a plurality of devices perform functions such as communication, storage, and/or control, etc. Thus, the parking lot management server 100 can have various types of hardware configurations.

Each functional block of the parking lot management server 100 is briefly described. The communication unit 101 is connected to the network, and receives and transmits various data through the network. Specifically, the communication unit 101 receives various data and transmits response data according to processing of various data through the network.

The storage unit 103 stores various data. The storage unit 103 stores various data for use of the parking lot management system and preferably stores the data in a database form. For example, the storage unit 103 includes at least a user (member, hereinafter ‘user’ and ‘member’ are used in combination) DB and a parking lot DB.

The user DB is a DB for managing users registered as members in the parking lot management system. The user DB is configured with a plurality of entries, and each entry is assigned to each user. An entry is configured with a plurality of fields and each field is predefined. One entry may be configured in various forms depending on the type of the field or the like.

For example, a user entry includes a user (member) name, an identifier (ID), a password, an e-mail address and the like, and further includes a mobile phone identifier, the vehicle license plate number (further, vehicle model name) and the like. The mobile phone identifier is an identifier used when connecting to the mobile phone or forwarding data through the network, and is, for example, an identifier of the mobile phone used for forwarding a mobile phone number or a push message. The vehicle license plate number is a number of a vehicle used by the corresponding user.

The user entry may further include credit card information and cyber money. The credit card information includes, for example, a credit card name, a credit card number, an expiration date and the like, and may further include a credit card company name, a card type, a password and the like. The credit card information can be used for automatic payment using a credit card.

The parking lot management server 100 can receive the credit card information from the user at the time of user (member) registration, receive approval through the PG server 500, and receive an approval number. The approval number designated to specific credit card information can be used for credit card payment afterward. The cyber money is online money provided by the present system. The cyber money can be charged with credit card points or can be paid by the credit card.

The user entry further includes available and pre-purchased parking product information. The parking product information includes a parking lot identifier, a parking product identifier in the parking lot, and may further include duration, purchase price and the like.

The user entry may further include parking lot vehicle entry and exit information. The parking lot vehicle entry and exit information includes the parking lot identifier, the entry time, the exit time, a parking fee, discount details and the like. The discount details include details of discount applied when using the corresponding parking lot.

As can be seen from the user entry, the user (member) can pre-purchase the parking product or can make the deferred payment using a credit card after entering the parking lot. In addition, the user can pay the parking fee using the points.

The parking lot DB is a DB for managing parking lots registered in the present parking lot management system. The parking lot DB is configured with a plurality of entries. Each parking lot entry corresponds to one parking lot and is configured with a plurality of fields. One entry may be configured in various forms depending on the type of the field and the like.

One parking lot entry corresponds to one parking lot, and includes a parking lot name, the parking lot identifier, a password, an address (location), the total number of parking spaces, and the number of available parking spaces and the like. In addition, the parking lot entry stores information about the parking product provided by the corresponding parking lot. For example, the parking lot entry can store a parking product name such as a daily ticket, a weekly ticket, a monthly ticket, etc. provided by the corresponding parking lot, the parking product identifier (this identifier may be the parking product name) for distinguishing each parking product name, a parking product price and the like, and provide them to a certain user. The parking lot entry further includes manager information. The manager information includes a manager name and an identifier of the manager's portable terminal. The identifier of the manager's portable terminal enables access to the corresponding terminal, and may be, for example, a mobile phone number or a mobile phone address (for example, an Internet address or a MAC address).

The parking lot entry further includes a user's use list. The user's use list stores contents related to his/her use of the present parking lot, and each entry of the user's use list stores a user identifier, the vehicle license plate number, the entry time, the exit time, a settled parking fee and the like. The parking lot entry further includes a parking product-use list that indicates a user who has purchased the parking product provided by the parking lot. Each parking product entry of the parking product-use list includes at least the user identifier, a purchased parking product name, and/or the parking product identifier.

The user's use list includes a vehicle entry-use list. The vehicle entry-use list is a list that includes the user identifier, the vehicle license plate number, and the entry time and indicates vehicles (or vehicle users) that have not yet exited the parking lot. The vehicle entry-use list indicates that a vehicle or a vehicle user that has entered but has not yet exited the parking lot.

The user's use list and the parking product-use list are searchable. For example, it is possible to identify the number of vehicles that have entered but have not yet exited the parking lot, to identify vehicles that have entered the parking lot during a certain period of time, and to identify when a certain vehicle has entered and exited the parking lot.

The parking lot entry further includes parking lot setting information. For example, the parking lot entry can store information such as the number of available parking spaces in the corresponding parking lot as setting information, and then can obtain the number of available parking spaces or whether the parking lot is full or not in association with the vehicle entry-use list.

The database stored in the storage unit 103 can be accessed and modified by the control unit 105.

The connection unit 107 transmits and receives data between the storage unit 103, the communication unit 101, and the control unit 105. The connection unit 107 may be configured with a parallel bus or a serial bus, or may be configured with a local network. The configuration of the connection unit 107 may vary depending on the hardware configuration example of the parking lot management server 100.

The control unit 105 controls the blocks of the parking lot management server 100. The control unit 105 receives various requests and data through the communication unit 101, processes the corresponding request or data by using the database, and forwards the processing result to the communication unit 101 to transmit the processing result to the device that has sent the request or data.

Several processing flows in the communication unit 101 will be briefly described. The communication unit 101 receives vehicle entry information including the vehicle license plate number from the local parking management terminal 410 through the network and forwards the received vehicle entry information to the control unit 105. The control unit 105 generates a vehicle entry guide message guiding the vehicle associated with the vehicle license plate number of the vehicle entry information to enter a certain parking lot. The control unit 105 identifies a user and a mobile phone that are mapped with the vehicle license plate number in the database (user DB) by using the vehicle license plate number or the like, and transmits the generated vehicle entry guide message to the identified mobile phone (for example, identified by using the mobile phone identifier). For transmission of the vehicle entry guide message to the mobile phone, the control unit 105 forwards the vehicle entry guide message to the communication unit 101 and the communication unit 101 transmits the message to the corresponding mobile phone by using the mobile phone identifier. The vehicle entry guide message may be a push message serviced over the Internet. Accordingly, the vehicle entry guide message may be forwarded to the corresponding mobile phone through a push server.

The vehicle entry guide message includes, for example, information on the parking lot where the vehicle associated with the vehicle license plate number enters, and guide information on a partnership store associated with this parking lot, and the corresponding information is displayed on the mobile phone that has received the information.

The control unit 105 can receive vehicle exit information for vehicle exit from the parking lot from the local parking management terminal 410. The vehicle exit information includes the vehicle license plate number, and settlement information used to settle the parking fee. The control unit 105 settles the parking fee of a vehicle associated with the vehicle license plate number by using the settlement information. The control unit 105 generates blocking bar control information according to the settlement of the parking fee, and forwards the blocking bar control information to the communication unit 101 to transmit the blocking bar control information to the local parking system 400 (local parking management terminal 410).

Moreover, the control unit 105 can receive a remote call request from the local parking system 400. The control unit 105 identifies the manager's portable terminal 300 from the remote call request. For example, the control unit 105 extracts a parking lot entry from the storage unit 103 by using the parking lot identifier of the local parking management terminal 410 that has sent the remote call request, and extracts the identifier of the manager's portable terminal from manager information of the extracted parking lot entry. Then, the control unit 105 transmits the connection request to the manager's portable terminal 300 for connection with the device of the local parking system 400 that has sent the remote call request. Then, the control unit 105 can arbitrate establishment of the video channel between the device and the manager's portable terminal 300.

As described above, the control unit 105 receives and processes various data through the communication unit 101, and transmits the processing result. The processing flow in the control unit 105 will be described more in detail with reference to FIG. 4 and the like.

FIG. 3 is an exemplary system block diagram showing a manager's portable terminal.

Referring to FIG. 3, the manager's portable terminal 300 includes an input unit 301, a communication unit 303, a storage unit 305, a display unit 307, a control unit 309, and a connection unit 311. The block diagram of FIG. 3 preferably represents a functional block diagram, and the manager's portable terminal 300 has hardware for implementing the functional block diagram. The manager's portable terminal 300 allows the manager to remotely manage the corresponding parking lot without having to be present at the parking lot.

Each block will be briefly described. The input unit 301 receives input from the manager (user). The input unit 301 includes, for example, a plurality of buttons or a touch panel and receives a signal indicating user's input. The received signal can be forwarded to the control unit 309. The user's input may be an input signal indicating a selection for an icon displayed on the display unit 307.

The communication unit 303 is connected to the network to receive and transmit various data. The communication unit 303 is provided with a chipset for wireless communication to be connected to the mobile communication network or the Internet, and is configured to wirelessly receive and transmit data. For example, the communication unit 303 receives the connection request from the parking lot management server 100 and transmits a response to the connection request to the parking lot management server 100. In addition, the communication unit 303 receives a video signal directly from the parking lot management server 100 or from the local parking system 400 (local parking management terminal 410) through the established video channel and forwards the received video signal to the control unit 309.

The storage unit 305 stores various data and programs. The storage unit 305 stores at least a control program for managing events of the manager's portable terminal 300 and a parking lot management program for managing a certain parking lot by accessing the parking lot management server 100. The storage unit 305 includes volatile memory and/or non-volatile memory, and may further include a hard disk and the like.

The control program is configured to receive an event (data) through the communication unit 303 and to perform specific processing according to the corresponding event. For example, the control program can receive an event of the connection request from the communication unit 303 and can execute the parking lot management program according to the corresponding connection request. The parking lot management program can be executed automatically or through user's input (confirmation). The control program may be a system program or a kernel program.

The parking lot management program is an application program and preferably an App program that is executed on a smartphone.

The display unit 307 includes an LCD and an LED module to display a single image or a continuous image. For example, the display unit 307 outputs the video signal received through the communication unit 303 and decoded, and displays the corresponding video image.

The control unit 309 controls the blocks of the manager's portable terminal 300. The control unit 309 is provided with a processing unit known as an application (AP) processor, a CPU, an MPU, or the like. The processing unit loads various programs stored in the storage unit 305 and controls other blocks according to the loaded programs.

For example, the control unit 309 controls such that the control program that has received the connection request through the communication unit 303 and has recognized the event of the connection request executes the App program, which is the parking lot management program. The parking lot management program that has been executed establishes a video channel with a device of the parking lot that has induced the connection request, and receives the video signal from the established video channel through the communication unit 303. The parking lot management program decodes the received video signal and outputs the decoded video signal to a certain area of the display unit 307.

The connection request includes a vehicle license plate number of a vehicle user that has sent a remote call, a discount item, and a parking fee to be settled. Each information is displayed on the display unit 307 by the control unit 309. In addition, the control unit 309 displays on the display unit 307 an icon for application of discount item. The manager can confirm a paper discount ticket or the like through confirmation of the decoded video signal or the like, and forward input indicating selection of the corresponding icon to the control unit 309 through the input unit 301. The control unit 309 that has received a selection input indicating selection of the icon for application of the discount item transmits an application request for the discount item to the parking lot management server 100 through the communication unit 303.

The parking lot management server 100 can forward a parking fee discounted in accordance with the application request to both the manager's portable terminal 300 and the local parking system 400 (local parking management system 410). Accordingly, the vehicle user can pay the discounted parking fee using a registered credit card or a credit card provided by an automated payment machine.

Then, the parking lot management server 100 or the manager's portable terminal 300 confirms the corresponding payment and forwards blocking bar control information for raising the blocking bar to the local parking system 400. Afterward, the exit gate device 450 of the local parking system 400 can open the blocking bar according to the corresponding control information.

The parking lot management program executed by the control unit 309 includes various icons, and is configured such that sub-icons or sub-menus are displayed by selecting the icons. The parking lot management program has an icon (menu) for connection to the parking lot management server 100 and for environment setting, and displays parking status information of the parking lot being managed. The parking status information indicates, for example, the number of vehicles currently parked in the parking lot or further indicates the total number of parking spaces available for parking.

The parking lot management program may include a plurality of menu icons or status bars, such as an icon for managing a parking product being sold, an icon for applying a parking discount, a status bar for obtaining a current parking status, an icon for monitoring the video signal of the camera and the like, and further includes an icon for setting parking lot environment. Each icon is selectable.

When the manager selects the icon for monitoring the video signal, sub-icons can be displayed. The sub-icons include, for example, a plurality of camera selection icons for selecting a specific camera 490 or a camera module of a specific device. Below the camera selection icons of the display unit 307, there is a video area for outputting the video signal. The video area outputs a different video signal according to the selection of a specific camera selection icon.

The output to the display unit 307 for monitoring of the video signal can be controlled by the control unit 309 and can be directly output according to the connection request without selecting another menu.

A representative control flow in the control unit 309 utilizing the parking lot management program will be described more in detail with reference to FIGS. 4 and 5.

The connection unit 311 transmits and receives data between the input unit 301, the communication unit 303, the storage unit 305, the display unit 307, and the control unit 309. The connection unit 311 may be configured with a parallel bus or a serial bus, or may be configured to employ one-to-one communication.

FIG. 4 is a view showing an exemplary control flow in which remote control of the parking lot is achieved utilizing the manager's portable terminal 300. The flow of FIG. 4 is accomplished through cooperation between various devices. Here, the contents described with reference to FIGS. 1 to 3 will be briefly described.

First, the manager of the parking lot registers as a parking lot member in the parking management system. According to the registration, the parking lot management server 100 newly generates the parking lot entry in the parking lot DB and records information in various fields of the parking lot entry. Accordingly, the parking lot management server 100 can specify the manager's portable terminal 300 that will manage the parking lot remotely, and information for specifying the manager's portable terminal 300 is recorded in the manager information.

The manager's portable terminal 300 can log in through the parking lot management program provided on the parking lot management server 100. The manager's portable terminal 300 can set the parking environment (see \textcircled{1}) by interworking with the parking lot management server 100.

For example, the manager can register the total number of parking spaces available for parking in the parking lot entry through the input unit 301 and register available parking product information.

According to the operation of the parking lot, the local parking system 400 recognizes an entering vehicle, generates the vehicle entry information indicating entry of the recognized vehicle, and forwards the vehicle entry information to the parking lot management server 100 (see \textcircled{2}). The vehicle entry information includes the vehicle license plate number, the entry time, the vehicle image captured in the entrance gate device 430 and the like.

Upon receipt of the vehicle entry information, the parking lot management server 100 identifies the parking lot entry assigned to the parking lot that has transmitted the vehicle entry information and updates the parking status information of the corresponding parking lot entry (see \textcircled{3}). The parking status information indicates or includes, for example, the number of available parking spaces. In other words, in the initial state, the number of available parking spaces is set to the total number of parking spaces, and the number of parking spaces is reduced by one upon receipt of one vehicle entry information. In addition, the parking lot management server 100 increases the number of available parking spaces by one upon receipt of the vehicle exit information indicating exit of the parked vehicle.

The parking lot management server 100 transmits the updated parking status information to the manager's portable terminal identified through the manager information of the parking lot entry (see \textcircled{4}). The portable terminal that has received the parking status information can display the current parking status in real time through the parking lot management program being executed.

Meanwhile, the user who intends to exit the parking lot after entering the parking lot can automatically exit the parking lot.

For automatic vehicle exit, a vehicle approaches the exit gate device 450 and the exit gate device forwards the vehicle license plate number, the exit time, and the vehicle image of the vehicle to be exited to the local parking management terminal 410. The local parking management terminal 410 determines from the vehicle license plate number the entry time that has already been stored in accordance with generation of the vehicle entry information, and calculates the parking time and the corresponding parking fee from the entry time and the exit time. In addition, the local parking management terminal 410 may determine whether the user associated with to the vehicle license plate number is a user who has already purchased the parking product. The local parking management terminal 410 transmits the vehicle exit information including the vehicle license plate number, the entry time, the exit time, the parking time, and the parking fee to be settled to the parking lot management server 100. The parking lot management server 100 can store the received vehicle exit information, discount the parking fee by using the user entry or the like of the user DB, and pay the parking fee by using the credit card information (cyber money) by interworking with the PG server 500. Alternatively, the parking lot management server 100 may pay the parking fee by using the user entry or the parking product information of the parking lot DB.

When the parking lot management server 100 fails to identify the user from the vehicle exit information, the parking lot management server can forward a response indicating that user identification is impossible to the local parking management terminal 410. The local parking management terminal 410 forwards a signal based on this response to the exit gate device 450 through the local network and the exit gate device 450 can output the signal through the input/output module.

When automatic vehicle exit is impossible or when the user intends to send a call, the vehicle user can call the manager through the input/output module provided at the device. The vehicle user presses a call button provided at the exit gate device 450 or a call button provided at the input/output module of the settlement device 470. The corresponding device generates a signal (data) indicating pressing of the call button of the input/output module and forwards the signal to the local parking management terminal 410.

The local parking management terminal 410 generates the remote call request according to the received signal and transmits the generated remote call request to the parking lot management server 100 (see \textcircled{5}). The remote call request includes, for example, the vehicle license plate number, and depending on the type of the device, further includes the discount item or the parking fee to be calculated and settled at the corresponding parking lot.

The parking lot management server 100 receives the remote call request (see \textcircled{5}) and identifies from the remote call request the manager's portable terminal 300 used by the manager of the parking lot that has sent a remote call (see \textcircled{6}). For example, the parking lot management server 100 can recognize the parking lot identifier through a communication channel (e.g., a session channel) with the local parking system 400. The parking lot management server 100 extracts the parking lot entry by using the recognized parking lot identifier and extracts the identifier of the manager's portable terminal 300 assigned to the parking lot that has sent the remote call by using the manager information of the parking lot entry.

According to the identification of the manager's portable terminal 300, the parking lot management server 100 transmits the connection request to the manager's portable terminal 300 (see \textcircled{7}). The connection request includes the vehicle license plate number of the vehicle user who has sent the remote call, and further includes the discount item input or requested by the user and the parking fee calculated by the local parking management terminal 410 and the like.

The connection request is transmitted to the manager's portable terminal 300 through the mobile communication network or the Internet network and can be forwarded as a message. This message is operable as an event.

Upon receipt of the message of the connection request, the control program of the manager's portable terminal 300 displays the message of the connection request on the display unit 307 and executes the parking lot management program by user's input through the input unit 301. Alternatively, the control program can automatically execute the parking lot management program.

According to the execution of the parking lot management program, the manager's portable terminal 300 transmits a response to the parking lot management server 100. This response may indicate, for example, that access or connection to the parking lot management server 100 has been made. Upon receipt of the response, the parking lot management server 100 establishes the video channel between the manager's portable terminal 300 and the device that has sent the remote call request (see \textcircled{8}). Preferably, the video channel is a video channel established between the device that has sent the remote call request (such as the exit gate device 450 or the settlement device 470) and the manager's portable terminal 300 and can transmit and receive the compressed video signal in real time. Through the video channel, the manager's portable terminal 300 can receive the compressed video signal of the camera module provided in the device that has sent the request in real time and output the signal through the display unit 307.

Meanwhile, the connection request may be a request for settlement of the parking fee or a request for another request (for example, application request for the discount item). Accordingly, the connection request includes at least the vehicle license plate number and further includes the discount item (one hour discount, two hour discount, etc.) or the parking fee.

The received vehicle license plate number is displayed by the parking lot management program. The displayed vehicle license plate number can be modified or changed by the user's input through the input unit 301. The input through the input unit 301 or a search for the displayed vehicle license plate number can also be performed by the manager's portable terminal 300.

The manager's portable terminal 300 (parking lot management program) transmits a vehicle search request including the vehicle license plate number determined by the user's input or display to the parking lot management server 100 (see \textcircled{9}). The vehicle search request can be used for settlement (calculation) of the parking fee.

The parking lot management server 100 receives the vehicle search request (see \textcircled{9}) and searches the user DB or parking lot DB by using the vehicle license plate number of the vehicle search request to calculate the parking time and the parking fee (see \textcircled{10}). The calculation of the parking time and the parking fee can be performed, for example, by searching the vehicle exit information stored in the parking lot DB or the user DB.

A response to the vehicle search request including the calculated parking time and the parking fee is transmitted to the manager's portable terminal 300 (see \textcircled{11}). The vehicle search request and the corresponding processing (see \textcircled{9} to \textcircled{11}) may be omitted according to the design modification.

The manager's portable terminal 300 that has received the response to the vehicle search request displays the response on the display unit 307. In addition, the manager's portable terminal 300 can display an image icon for application of the discount item and receive the selection input for the icon. The discount item can be confirmed through the connected video channel. For example, the vehicle user can expose a discount coupon that is not automatically recognized, or the like to the camera module, and the manager can confirm the corresponding discount coupon through the video channel. Moreover, the manager can confirm the discount item input by the vehicle user through the portable terminal of the manager himself.

The manager of the manager's portable terminal 300 selects the icon for application of the discount item to apply the discount item, and transmits the application request for the discount item according to the selection to the parking lot management server 100 through the communication unit 303 (see \textcircled{12}).

The parking lot management server 100 that has received the application request for the discount item determines a discounted parking fee according to the application request, and calculates the determined parking fee by interworking with the local parking system 400 (local parking management terminal 410 or settlement device 470), etc. (see \textcircled{13}).

The settlement of the parking fee can be performed, for example, using a credit card or cash. The parking lot management server 100 confirms settlement completion of the parking fee and transmits information indicating settlement completion to the manager's portable terminal 300.

Accordingly, after confirming that the settlement is completed, the manager's portable terminal 300 selects open and close icons displayed on the display unit 307 to generate the blocking bar control information, and transmits the information to the parking lot management server 100 (see \textcircled{14}). The blocking bar control information is control data for opening and closing the blocking bar of a specific exit gate device 450.

The parking lot management server 100 transmits the blocking bar control information to the local parking management terminal 410 upon receipt of the blocking bar control information (see \textcircled{15}). The local parking management terminal 410 of the local parking system 400 generates a blocking bar control signal for opening and closing the specific exit gate device 450 upon receipt of the blocking bar control information and transmits the blocking bar control signal through the local network. The exit gate device 450 that has received the blocking bar control signal opens and closes the blocking bar according to the corresponding control signal.

Through the control flow as shown in FIG. 4, the manager can remotely control the parking lot and calculate the parking fee without having to be present at the parking lot. In addition, the manager can confirm the discount coupon or the like through the camera or the like to discount the parking fee as occasion demands.

FIG. 5 is a view showing an exemplary parking management control flow in the manager's portable terminal 300 by interworking with the parking lot management server 100. The control flow of FIG. 5 is performed by the control unit 309 of FIG. 3 and is preferably performed using the control program and the parking lot management program. Information and data transmitted and received between the manager's portable terminal 300 and the parking lot management server 100 are transmitted and received through the communication unit 303 of the manager's portable terminal 300. Here, the contents described with reference to FIGS. 1 to 4 will be briefly described.

First, the control unit 309 (control program) receives the event (see S101). The event can be received through the network or received through the input unit 301.

Upon receipt of the event, the control unit 309 determines whether the event is the connection request received from the parking lot management server 100 (see S103).

In the case that the event is the connection request, the control program executes the parking lot management program including the App program, and the parking lot management program generates a response according to the connection request and transmits the response to the parking lot management server 100 (see S105). According to the connection request, the parking lot management server 100 and the manager's portable terminal 300 configures a session or channel for data transmission/reception.

The connection request may include the vehicle license plate number of the vehicle user who has sent the remote call, the discount item, and the parking fee to be settled.

According to the connection request, the control unit 309 establishes the video channel with the device of the local parking system 400 under control (arbitration) of the parking lot management server 100 (see S107). The establishment of the video channel can be performed between the control unit 309 and the local parking management terminal 410. The local parking management terminal 410 can transmit one video signal of video signals of the plurality of cameras 490 or the camera modules to the manager's portable terminal 300 by carrying the one video signal in the established video channel. Since the connection request has been already sent by one device, the local parking management terminal 410 can transmit the video signal from the camera module of the device that has sent the remote call to the manager's portable terminal 300 through the video channel. The video channel utilizes a real-time protocol and is established between the local parking management terminal 410 of the device that has sent the remote call and the manager's portable terminal 300.

After establishment of the video channel or at the time of establishment of the video channel, the control unit 309 displays the video signal received through the video channel, the vehicle license plate number, the discount item, and the parking fee (see S109). The video signal is decoded and displayed in real time in a certain area of the display unit 307. The vehicle license plate number, the discount item, the parking fee and the like are displayed as a text image in an area different from the video area. The displayed vehicle license plate number can be modified by the user's input through the input unit 301, and the manager can search for and confirm the discount item or the parking fee associated with to the modified vehicle license plate number.

In addition, the control unit 309 displays the icon for requesting application of the discount item, along with other information and video.

The manager can obtain specific data or information through the video channel and select the icon for application of the discount item. The control unit 309 receives the selection input indicating selection of the icon through the input unit 301, generates the application request for requesting application of the displayed discount item, and transmits the application request to the parking lot management server 100 via the communication unit 303 (see S111).

Thereafter, the control unit 309 receives settlement completion information, which is a response to the application request, from the parking lot management server 100 (see S113). The manager who has confirmed that settlement according to the discount has been completed selects a blocking bar control icon (e.g., a selection icon for opening and closing the blocking bar such as ‘open’ or ‘close’) displayed also on the display unit 307 to generate the blocking bar control information. The manager's portable terminal 300 transmits the blocking bar control information according to the blocking bar control icon to the parking lot management server 100 (see S115).

Through this flow, the manager can connect with the vehicle user of the parking lot in real time, discount the parking fee, and remotely open and close the blocking bar of the parking lot.

On the other hand, when the event is not the connection request and is a selection input by the user for the parking lot management program, the control unit 309 displays a top menu in step S117 (see S117).

The top menu includes, for example, a parking status bar for displaying real-time parking status information, a parking product management icon, a camera monitoring icon, a vehicle entry/exit management icon, a free vehicle management icon and the like.

For displaying of the top menu, the control unit 309 receives the parking status information from the parking lot management server 100 and generates and displays the parking status bar from the received parking status information. The parking status bar includes, for example, at least one of information including the total number of parking spaces, the number of parked vehicles, and the number of available parking spaces.

The parking product management icon is an icon for managing by the manager the parking product being sold. A sub-menu is displayed by selecting the corresponding icon, and the corresponding sub-menu enables setting, modification and the like of the parking product being currently sold, and can confirm the purchase details of each parking product by interworking with the parking lot management server 100.

The vehicle entry/exit management icon is selected to display a sub-menu. The manager can identify and search for vehicles entering or exiting the corresponding parking lot on the sub-menu. The free vehicle management icon is an icon for managing a vehicle that can use the corresponding parking lot for free.

The camera monitoring icon is an icon for enabling monitoring of the plurality of cameras and control of other parking lots. The camera monitoring icon can be selected by the manager and the control unit 309 provides various icons and input windows by the selection input by the manager.

The control unit 309 receives the selection input for the camera monitoring icon through the input unit 301, and displays a plurality of camera selection icons in a certain area of the display unit 307 (see S119). For example, in the case that eight cameras are installed, including the camera module provided in the parking lot, eight camera selection icons are displayed in the uppermost area of the display area of the display unit 307.

A video area for outputting the video signal of the selected camera is located below the camera selection icons of the display area, and the decoded video signal is output through the video area. The various icons and input windows displayed according to the selection of the camera monitoring icon may be displayed according to the connection request. At this time, the video signal of the camera of the device by the connection request is output automatically and with priority.

Further, the icons (‘open’ and ‘close’) for controlling the blocking bar are located below the video area, and an input window and a search button for searching for the vehicle license plate number may be located under the icons. The input window for searching for the vehicle license plate number can be used to input the vehicle license plate number, and can be used for settlement of the parking fee and application of the discount item afterward.

The manager can select one of the displayed camera selection icons. The control unit 309 receives a selection input for a specific camera icon (see S121) and transmits a selection request according to the corresponding selection to the parking lot management server 100 or the local parking system 400 (local parking management terminal 410) (see S123).

The parking lot management server 100, particularly the local parking management terminal 410, receives the selection request for changing the camera designated to the video signal, digitally compresses the video signal from the camera, and then transmits the compressed video signal to the video channel that has been already established, whereafter the manager's portable terminal 300 receives the video signal from the selected camera (see S125), and then decodes and displays the signal in the video area (see S127).

Through this selection and confirmation of the video, it is also possible to remotely manage the parking lots.

Although embodiments of the present invention were described in detail above, the scope of the present invention is not limited to the embodiments and various changes and modifications from the spirit of the present invention defined in the following claims by those skilled in the art are also included in the scope of the present invention.

1. A parking lot management method performed by a parking lot management server, the method comprising the steps of:
receiving a remote call request from one local parking management terminal of a plurality of local parking management terminals;
extracting from a database a parking lot identifier of a parking lot of a plurality of parking lots being managed, the parking lot having sent the remote call request, and extracting from the database an identifier of a manager's portable terminal used by a manager of the parking lot that has sent the remote call request by using the extracted parking lot identifier;
transmitting to the manager's portable terminal a connection request for connection with the local parking management terminal that has sent the remote call request by using the extracted identifier of the manager's portable terminal;
upon receipt of a response to the connection request for connection with the local parking management terminal from the manager's portable terminal, establishing a video channel between the manager's portable terminal and the local parking management terminal that has sent the remote call request, the video channel transmitting a compressed video signal in real time; and
receiving from the manager's portable terminal an application request for a discount item and settling a parking fee by applying the discount item,
wherein the remote call request and the connection request include a vehicle license plate number of a vehicle user who has sent a remote call, the discount item, and the parking fee to be settled, the parking fee being calculated by applying the discount item to the parking fee to be settled, and
the manager's portable terminal receives through the established video channel the compressed video signal from a camera provided at a device connected to the local parking management terminal.

2. The method of claim 1, further comprising the steps of:
transmitting information indicating settlement completion to the manager's portable terminal and receiving from the manager's portable terminal blocking bar control information to open a blocking bar after settling the parking fee; and
transmitting the blocking bar control information to the one local parking management terminal having sent the remote call request.

3. The method of claim 1, further comprising the steps of:
receiving vehicle entry information from the one local parking management terminal of the plurality of local parking management terminals;
updating current parking status information upon receipt of the vehicle entry information; and
transmitting the updated current parking status information to the manager's portable terminal managing the parking lot related to the one local parking management terminal.

4. The method of claim 3, further comprising the steps of:
receiving a vehicle search request from the manager's portable terminal;
calculating a parking time and the parking fee of the vehicle license plate number in response to the vehicle search request; and
transmitting the calculated parking time and parking fee to the manager's portable terminal.

5. A parking lot management method performed by a portable terminal for remotely managing a parking lot, the method comprising the steps of:
receiving a connection request from a parking lot management server;
automatically executing an application program in response to the connection request upon receipt of the connection request and transmitting a response to the connection request to the parking lot management server; and
establishing, under arbitration of the parking lot management server, a video channel with a local parking management terminal of the parking lot that has induced the connection request, the video channel being capable of transmitting a compressed video signal in real time,
wherein the connection request includes a vehicle license plate number of a vehicle user who has sent a remote call, a discount item, and a parking fee to be settled, and
the method further includes the steps of:
displaying the vehicle license plate number, the discount item, the parking fee, and an icon for application of the discount item and displaying the compressed video signal received directly from the local parking management terminal through the established video channel; and
transmitting an application request for the discount item to the parking lot management server upon receipt of a selection input for the icon for application of the discount item.

6. The method of claim 5, further comprising the steps of:
receiving information indicating settlement completion from the parking lot management server after transmitting the application request;
generating blocking bar control information to open a blocking bar by receiving selection of displayed open and close icons after receiving the information indicating settlement completion; and
transmitting the blocking bar control information to the parking lot management server.

7. The method of claim 5, further comprising the steps of:
displaying through the video channel a plurality of camera selection icons for selecting a video signal to be displayed; and
receiving an input for selecting the camera selection icon,
wherein the displaying of the video signal receives and displays through the established video channel the compressed video signal designated to a camera selected by the input.

8. A portable terminal remotely managing a parking lot, the portable terminal comprising:
an input unit receiving an user's input;
a communication unit receiving a connection request from a parking lot management server and transmitting a response to the connection request to the parking lot management server;
a control unit automatically executing an application program in response to the connection request through the communication unit, generating the response to the connection request, and forwarding the response to the communication unit, the control unit establishing, under arbitration of the parking lot management server, a video channel with a local parking management terminal of the parking lot that has induced the connection request, the video channel being capable of transmitting a compressed video signal in real time, the control unit decoding the video signal from the established video channel; and
a display unit outputting the decoded video signal from the established video channel,
wherein the connection request includes a vehicle license plate number of a vehicle user who has sent a remote call, a discount item, and a parking fee to be settled, and
the control unit outputs the vehicle license plate number, the discount item, the parking fee, and an icon for application of the discount item through the display unit, receives a selection input for the icon for application of the discount item through the input unit, and transmits an application request for the discount item to the parking lot management server through the communication unit.

9. The portable terminal of claim 8, wherein the control unit receives information indicating settlement completion from the parking lot management server through the communication unit, generates blocking bar control information to open a blocking bar by receiving selection of displayed open and close icons through the input unit after receiving the information indicating settlement completion, and transmits the blocking bar control information to the parking lot management server through the communication unit.

10. A parking lot management system, comprising:
the portable terminal of claim 8 remotely managing the parking lot.

11. The parking lot management system of claim 10, further comprising:
the parking lot management server managing a plurality of parking lots,
wherein the parking lot management server identifies the portable terminal from information received from the local parking management terminal and transmits a message based on the information to the identified portable terminal.
